(19) United States
(12) Patent Application Publication
(10) Pub. No.: US 2002/0012760 A1
(43) Pub. Date: Jan. 31, 2002

(54) ANTIMICROBIAL FOOD TRAY

(76) Inventors: JOHN E. BARRY, DERRY, NH (US); JEFFREY A. TROGOLO, BOSTON, MA (US)

Correspondence Address: AgION Technologies, LLC, Attn: Edward K. Welch II, Esq., 60 Audubon Road, Wakefield, MA, 01880, US

(21) Appl. No.: 09/260,186

(22) Filed: Mar. 1, 1999

(51) Int. Cl. B32B 1/02

(52) U.S. Cl. 428/35.7

(57) ABSTRACT

A food serving tray with at least one depressed section having a surface with which food comes into contact and the material forming the surface contains an inorganic antimicrobial agent. The tray can be formed from a plastic resin containing the antimicrobial agent or the agent being contained in a coating applied to the tray.

### FIELD OF THE INVENTION

The invention relates to food trays having antimicrobial properties.

### BACKGROUND OF THE INVENTION

Food trays are in common use in connection with the serving of food. In general, such trays are made of a solid material, such as metal or plastic, and have a number of compartments in the form of impressions in the tray. The tray holds packaged food items as well as items which are unpackaged, for example, foods which are loaded onto the tray as the user passes in a serving line.

Typically, after use the trays are either wiped clean or processed in a washer and then stacked for storage. When the trays are maintained in the stacked condition, there may be a small amount of moisture or other type of the residue remaining which provides a site for the growth of bacteria. Therefore, when the tray is reused it is possible that the bacteria can be transmitted to new food which is placed into one of the tray compartments for ingestion by the user. Of course, it is desirable to prevent this.

### BRIEF DESCRIPTION OF THE INVENTION

The present invention is directed to a food tray having antimicrobial properties. In accordance with a preferred embodiment of the invention, the tray is molded from a resin that contains the agent. The antimicrobial agent is of the inorganic type, preferably a zeolite. In another embodiment, the surface of a food tray, either of metal or plastic, on which the food is placed with the antimicrobial agent.

### OBJECTS OF THE INVENTION

It is therefore an object of the invention to provide a food tray having antimicrobial properties.

An additional object is to provide a food tray with having a zeolite to produce an antimicrobial effect.

A further object is to provide a food tray molded from plastic resin containing an inorganic antimicrobial agent.

Another object is to provide a food tray wherein the surface on which the food has an inorganic antimicrobial agent.

### BRIEF DESCRIPTION OF THE DRAWINGS

Other objects and advantages of the present invention will become apparent upon reference to the following specification and annexed drawings in which:

FIG. 1 is a perspective in the view of a food tray in accordance with the invention; and

FIG. 2 is a part perspective and part cross-sectional view of a further embodiment of the invention.

### DETAILED DESCRIPTION OF THE INVENTION

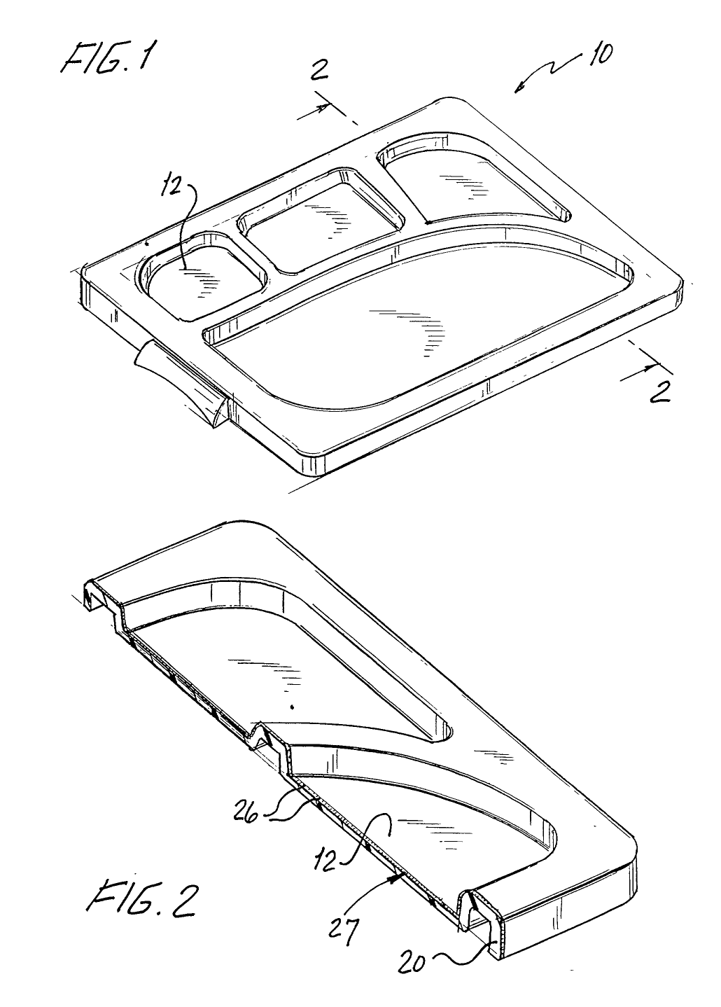

FIG. 1 shows in a typical food tray 2 of generally rectangular shape. The food tray has a number of compartments 12 of different shape. Both the shape and size of the tray and the shape, size and number of compartments 12 are arbitrary and can be made as desired. The tray may be flexible or rigid.

In accordance with the invention, the collar and lid components are made of material that has antimicrobial properties. The tray 10 of FIG. 1 is shown of a polymeric resin material. Suitable polymeric materials for forming the tray include high density polyethylene, low density polyethylene, ultra high molecular weight polyethylene, polypropylene, polycarbonate, acrylic, polyvinyl chloride (“PVC”), flexible polyvinyl chloride (“FPVC”), polyurethene, ABS, nylon or polyester, or blends thereof. The polymeric resin used for forming the tray contains an inorganic antimicrobial agent.

The antimicrobial ceramic may be combined with the polymeric resin to between 5-30 weight % to form a concentrated masterbatch. The concentrate is then combined with the resin to reduce to the final concentration in the particular layer of interest to between 0.1 and 20%, preferably 0.5 to 10%, most preferably 1 to 5%. The inorganic antimicrobial may be incorporated into one or more of the layers of the food tray. A preferred inorganic antimicrobial agent that can be incorporated into a resin suitable for the tray is an antibiotic zeolite and particularly zeolites incorporated as ceramic particles. Suitable zeolites and a method for incorporating them into the resin is disclosed in U.S. Pat. No. 4,938,955. The resins can be those such as polyethylene, polypropylene, polystyrene, polyvinyl chloride, ABS resins and others disclosed in said patent. The zeolite is kneaded into the resin and the composite of the resin and the zeolite are then processed in a conventional manner, such as by injection molding, to form the tray 10 with compartments 12 described above.

After the tray is molded, the agent is available over the entire surface of the tray on which the food is placed, that is, on all the potential bacteria growth sites. The agent prevents the growth of bacteria. Other antimicrobial agents are also suitable, as described below, and would be processed in the same manner with the resin.

The tray 10 has a thickness of between about 2 mils to about 1.27 cm (½ inch). The thinner trays can be used as inserts that are fastened onto existing trays of cardboard, plastic or metal by any suitable technique, such as an adhesive, welding, or any type of mechanical fastener. The trays of greater thickness dimension can be used without being added to an existing tray. In either case, the surface that the food contacts has the inorganic agent.

As to the inorganic antimicrobial agent incorporated in the resin, a number of metal ions, which are inorganic materials, have been shown to possess antibiotic activity, including silver, copper, zinc, mercury, tin, lead, bismuth, cadmium, chromium and thallium ions. These antibiotic metal ions are believed to exert their effects by disrupting respiration and electron transport systems upon absorption into bacterial or fungal cells. Antimicrobial metal ions of silver, gold, copper and zinc, in particular, are considered safe even for in vivo use. Antimicrobial silver ions are particularly useful for in vivo use due to the fact that they are not substantially absorbed into the body. That is, if such materials are used they should pose no hazard.

In one embodiment of the invention, the inorganic antibiotic metal containing composition is an antibiotic metal salt. Such salts include silver acetate, silver benzoate, silver carbonate, silver ionate, silver iodide, silver lactate, silver laureate, silver nitrate, silver oxide, silver palpitate, silver protein, and silver sulfadiazine. Silver nitrate is preferred. These salts are particularly quick acting, as no release from ceramic particles is necessary to function antimicrobially.

Antibiotic zeolites have been prepared by replacing all or part of the ion-exchangeable ions in zeolite with ammonium ions and antibiotic metal ions, as described in U.S. Pat. Nos. 4,938,958 and 4,911,898. Such zeolites have been incorporated in antibiotic resins (as shown in U.S. Pat. Nos. 4,938,955 and 4,906,464) and polymer articles (U.S. Pat. No. 4,775,585). Polymers including the antibiotic zeolites have been used to make refrigerators, dish washers, rice cookers, plastic film, plastic chopping boards, vacuum bottles, plastic pails, and garbage containers. Other materials in which antibiotic zeolites have been incorporated include flooring, wall paper, cloth, paint, napkins, plastic automobile parts, catheters, bicycles, pens, toys, sand, and concrete. Examples of such uses are described in U.S. Pat. Nos. 5,714,445; 5,697,203; 5,562,872; 5,180,585; 5,714,430; and 5,102,401. These applications involve slow release of antibiotic silver from the zeolite particles which is suitable for the food trays of the invention.

The ceramics used in the antibiotic ceramic particles of the present invention include zeolites, hydroxy apatite, zirconium phosphates or other ion- exchange ceramics. Zeolites are preferred, and are described in the preferred embodiments referred to below. Hydroxy apatite particles containing antimicrobial metals are described, e.g., in U.S. Pat. No. 5,009,898. Zirconium phosphates containing antimicrobial metals are described, e.g., in U.S. Pat. Nos. 5,296,238; 5,441,717; and 5,405,644.

Antibiotic zeolites are well-known and can be prepared for use in the present invention using known methods. These include the antibiotic zeolites disclosed, for example, in U.S. Pat. Nos. 4,938,958 and 4,911,898.

Either natural zeolites or synthetic zeolites can be used to make the antibiotic zeolites used in the present invention. “Zeolite” is an aluminosilicate having a three dimensional skeletal structure that is represented by the formula:

XM₂/nO—Al₂O₃—YSiO₂—ZH₂O.

M represents an ion-exchangeable ion, generally a monovalent or divalent metal ion, n represents the atomic valency of the (metal) ion, X and Y represent coefficients of metal oxide and silica respectively, and Z represents the number of water of crystallization. Examples of such zeolites include A-type zeolites, X-type zeolites, Y-type zeolites, T-type zeolites, high-silica zeolites, sodalite, mordenite, analcite, clinoptilolite, chabazite and erionite. The present invention is not restricted to use of these specific zeolites.

The ion-exchange capacities of these zeolites are as follows: A-type zeolite=7 meq/g; X-type zeolite=6.4 meq/g; Y-type zeolite=5 meq/g; T-type zeolite=3.4 meq/g; sodalite=11.5 meq/g; mordenite=2.6 meq/g; analcite=5 meq/g; clinoptilolite=2.6 meq/g; chabazite=5 meq/g; and erionite=3.8 meq/g. These ion-exchange capacities are sufficient for the zeolites to undergo ion-exchange with ammonium and antibiotic metal ions.

The specific surface area of preferred zeolite particles is preferably at least 150 m²/g (anhydrous zeolite as standard) and the SiO₂/Al₂O₃ mol ratio in the zeolite composition is preferably less than 14, more preferably less than 11.

The antibiotic metal ions used in the antibiotic zeolites should be retained on the zeolite particles through an ion-exchange reaction. Antibiotic metal ions which are adsorbed or attached without an ion-exchange reaction exhibit a decreased bacteriocidal effect and their antibiotic effect is not long-lasting. Nevertheless, it is advantageous for imparting quick antimicrobial action to maintain a sufficient amount of surface adsorbed metal ion.

In the ion-exchange process, the antibiotic metal ions tend to be converted into their oxides, hydroxides, basic salts etc. either in the micropores or on the surfaces of the zeolite and also tend to deposit there, particularly when the concentration of metal ions in the vicinity of the zeolite surface is high. Such deposition tends to adversely affect the bacteriocidal properties of ion-exchanged zeolite.

In an embodiment of the antibiotic zeolites, a relatively low degree of ion exchange is employed to obtain superior bacteriocidal properties. It is believed to be required that at least a portion of the zeolite particles retain metal ions having bacteriocidal properties at ion-exchangeable sites of the zeolite in an amount less than the ion-exchange saturation capacity of the zeolite. In one embodiment, the zeolite employed in the present invention retains antimicrobial metal ions in an amount up to 41% of the theoretical ion-exchange capacity of the zeolite. Such ion-exchanged zeolite with a relatively low degree of ion-exchange may be prepared by performing ion-exchange using a metal ion solution having a low concentration as compared with solutions conventionally used for ion exchange.

The antibiotic metal ion is preferably present in the range of from about 0.1 to 20 wt. % of the zeolite. The antibiotic zeolite particles used in the present invention, ion-exchangeable ions present in zeolite, such as sodium ions, calcium ions, potassium ions and iron ions, are preferably partially replaced with ammonium and antibiotic metal ions. Such ions may coexist in the antibiotic zeolite particle since they do not prevent the bacteriocidal effect. Antibiotic metal ions include ions of silver, copper, zinc, mercury, tin, lead, bismuth, cadmium, chromium and thallium.

In one embodiment, the zeolite contain from 0.1 to 20 wt. % of silver ions and from 0.1 to 20 wt. % of copper or zinc ions. Although ammonium ion can be contained in the zeolite at a concentration of about 20 wt. % or less of the zeolite, it is desirable to limit the content of ammonium ions to from 0.5 to 15 wt. %, preferably 1.5 to 5 wt. %. Weight % described herein is determined for materials dried at temperatures such as 110° C., 250° C. or 550° C. as this is the temperature employed for the preferred post-manufacturing drying process.

A preferred antibiotic zeolite is type A zeolite containing either a combination of ion-exchanged silver, zinc, and ammonium or silver and ammonium. One such zeolite is manufactured by Shinagawa, Inc. a/k/a/ Shinanen under the product number AW-10N and consists of 0.6% by weight of silver ion-exchanged in Type A zeolite particles having an average particle size of about 2.5μ. Another formulation, AJ-10N, consists of about 2% by weight silver ion-exchanged in Type A zeolite particles having an average particle size of about 2.5μ. Another formulation, AW-80, contains 0.6% by weight of silver ion-exchanged in Type A zeolite particles having an average particle size of about 1.0μ. Another formulation, AJ-80N, consists of about 2% by weight silver ion-exchanged in Type A zeolite particles having an average particle size of about 1.0μ. These zeolites preferably contain about between 0.5% and 2.5% by weight of ion-exchanged ammonium.

The zeolites are often obtained in master batches of low density polyethylene, polypropylene, or polystyrene, containing 20 wt. % of the zeolite. Thus, they can be easily mixed with the resins used as thermoplastic materials for forming the composite resin used to make or coat the food trays of the invention.

The antibiotic particles are preferably present in a concentration by weight in the resin used to make or coat the articles of from 0.01 to 10.0 wt %, more preferably from 0.01 to 8.0 wt %, and most preferably from 0.1 to 5.0 wt %. They are present on the surface of the food tray to be contacted by the food.

The antibiotic properties of the antibiotic zeolite particles of the invention may be assayed while in aqueous formulations using conventional assay techniques, including for example determining the minimum growth inhibitory concentration (MIC) with respect to a variety of bacteria, eumycetes and yeast. In such a test, the bacteria listed below may be employed:

Bacillus cereus var mycoides;

Escherichia coli;

Pseudomonas aeruginosa;

Staphylococcus aureus;

Streptococcus faecalis;

Aspergillus niger;

Aureobasiduim pullulans;

Chaetomium globosum;

Gliocladium virens;

Penicillum funiculosum;

Candida albicans; and

Saccharomyces cerevisiae.

The assay for determining MIC can be carried out by smearing a solution containing bacteria for inoculation onto a plate culture medium to which a test sample of the encapsulated antibiotic zeolite particles is added in a particular concentration, followed by incubation and culturing of the plate. The MIC is defined as a minimum concentration thereof required for inhibiting the growth of each bacteria.

Safety and biocompatibility tests were conducted on the antibiotic zeolites employed in the invention. ISO 10993-1 procedures were employed. The following results were obtained:

Cytotoxicity: Non-Toxic
Acute Systemic Toxicity: Non-Toxic
Intracutaneous Toxicity: Passed
Skin Irritation Test: Non-Irritant
Chronic Toxicity: No Observable Effect
In-vitro Hemolysis: Non-Hemolytic
30-day Muscle Implant Test: Passed
60-day Muscle Implant Test: Passed
90-day Muscle Implant Test: Passed
Ames Mutagenicity Test: Passed
Pyrogenicity: Non-Pyrogenic

Thus, the antibiotic zeolites are exceptionally suitable under relevant toxicity and biocompatibility standards for use in the food trays and are not adversely affected or deteriorated upon being contacted by foods and spilled beverages such as milk and fruit juices.

FIG. 2 shows a further embodiment of the invention. Here there is an existing tray base 20 which can be of plastic or metal, having the depressed compartments 12. Here the top of the tray has a coating 26 containing particles 27 of the inorganic antibiotic agent. The coating can be over the entire surface of the tray or only over the surface of the compartments into which the food is to be placed.

The coating 26 is formed and applied in a manner consistent with the tray base 20 construction and material. For example, the particles of the agent are mixed in a polymer or epoxy and the liquid is sprayed or painted onto the tray. The top surface of the tray can be roughened by sanding or sand blasting to provide better adherence of the coating 26. The particles of the agent in the coating are substantially uniformly dispersed over the surface of the tray with which the food comes into contact.

The coating approach has advantages in that used trays can be reclaimed. Also, the coating applied only to some or all of the compartments 12 into which the food is to be placed.

Specific features of the invention are shown in one or more of the drawings for convenience only, as each feature may be combined with other features in accordance with the invention. Alternative embodiments will be recognized by those skilled in the art and are intended to be included within the scope of the claims.

We claim:

1. A food serving tray having at least one depressed section with a surface area which can be contacted by food, at least said surface area of said tray containing an inorganic antimicrobial agent.

2. A food serving tray as in claim 1 wherein the entirety of said tray is of a plastic resin containing said antimicrobial agent.

3. A food serving tray as in claim 1 wherein said surface area is formed by a coating of a material containing said antimicrobial agent.

4. A food serving tray as in claim 1 wherein said agent is an antimicrobial metal containing composition that imparts substantial antimicrobial action.

5. A food serving tray as in claim 4 wherein said inorganic antimicrobial metal comprises antimicrobial ceramic particles comprising said metal.

6. A food serving tray as in claim 5 wherein said ceramic particles are selected from the group consisting of zeolite, hydroxy apatite, and zirconium phosphate.

7. A food serving tray as in claim 4 wherein said inorganic antimicrobial metal containing composition comprises a silver salt.

8. A food serving tray as in claim 7 wherein said silver salt is selected from the group consisting of silver acetate, silver benzoate, silver carbonate, silver ionate, silver iodide, silver lactate, silver laureate, silver nitrate, silver oxide, silver palpitate, silver protein, and silver sulfadiazine.

9. A food serving tray as in claim 8 wherein said silver salt is silver nitrate.

10. A food serving tray as in claim 5 wherein said antimicrobial ceramic particles comprise antimicrobial zeolite prepared by replacing all or part of the ion-exchangeable ions in zeolite with an antimicrobial metal ion.

11. A food serving tray as in claim 10 wherein said antimicrobial metal is selected from the group consisting of silver, copper, zinc, and gold.

12. A food serving tray as in claim 4 wherein said antimicrobial metal is silver.

13. The food serving tray of claim 2 wherein said inorganic antimicrobial agent comprises from 0.25% to 10.0% by total weight of the resin and agent.

14. A food serving tray as in claim 1 wherein said antimicrobial agent is in particle form and the size of said particles is from 0.25 to 10.0 microns.

15. A food serving tray as in claim 3 wherein said coating is bonded to said tray and contains particles of said antimicrobial agent.

16. A food serving tray as in claim 15 wherein said agent is an antimicrobial metal containing composition that imparts substantial antimicrobial action.

17. A food serving tray as in claim 16 wherein said inorganic antimicrobial metal comprises antimicrobial ceramic particles comprising said metal.

18. A food serving tray as in claim 17 wherein said ceramic particles are selected from the group consisting of zeolite, hydroxy apatite, and zirconium phosphate.

19. A food serving tray as in claim 16 wherein said inorganic antimicrobial metal containing composition comprises a silver salt.
